(19) United States
(12) Patent Application Publication
(10) Pub. No.: US 2026/0023224 A1
(43) Pub. Date: Jan. 22, 2026

(54) POSITIONING STRUCTURE FOR SILICON SUBSTRATE

(71) Applicant: KYOCERA Corporation, Kyoto (JP)

(72) Inventor: Naoki MATSUI, Yokohama-shi (JP)

(73) Assignee: KYOCERA Corporation, Kyoto (JP)

(21) Appl. No.: 19/266,722

(22) Filed: Jul. 11, 2025

(30) Foreign Application Priority Data
Jul. 22, 2024 (JP) 2024-117176

(51) Int. Cl. G02B 6/42; G02B 6/36; G02B 6/38

(52) U.S. Cl. CPC G02B 6/4231; G02B 6/3652; G02B 6/3882

(57) ABSTRACT

A positioning structure for a silicon substrate includes a silicon substrate and a guide pin. The silicon substrate includes a substrate surface in which at least one groove having a linear shape is formed. The guide pin is positioned along the at least one groove. The at least one groove reaches a side surface of the silicon substrate, and the guide pin extends beyond the side surface to the outside of the silicon substrate.

### CROSS REFERENCES TO RELATED APPLICATIONS

The present application claims priority to Japanese Patent Application No. 2024-117176, filed Jul. 22, 2024, the entire disclosure of which is incorporated herein by reference.

### BACKGROUND OF THE INVENTION

### 1. Field of the Invention

The present disclosure relates to a positioning structure for a silicon substrate.

### 2. Description of the Related Art

Silicon photonics has attracted attention for achieving compact optical transceivers. Japanese Unexamined Patent Application Publication No. 2017-90500 discloses that an optical connection component is attached beforehand to a silicon photonics element in order to optically connect the silicon photonics element and an optical waveguide to each other. In Japanese Unexamined Patent Application Publication No. 2017-90500, the optical coupling between the silicon photonics element and the optical connection component is achieved through active optical alignment in which positioning of the optical connection component is performed while checking optical continuity.

### SUMMARY OF THE INVENTION

In an embodiment, (1) a positioning structure for a silicon substrate includes a silicon substrate and a guide pin. The silicon substrate includes a substrate surface in which at least one groove having a linear shape is formed. The guide pin is positioned along the at least one groove. The at least one groove reaches a side surface of the silicon substrate, and the guide pin extends beyond the side surface to outside of the silicon substrate.

(2) The positioning structure for the silicon substrate according to (1) may further include a connector receiving portion. The connector receiving portion may be positioned with respect to the silicon substrate by the guide pin passing through the connector receiving portion.

(3) In the positioning structure for the silicon substrate according to (2), an optical waveguide may be formed in the silicon substrate, and a port through which light is input or output to the optical waveguide may be formed on the side surface. The connector receiving portion may be a receptacle configured to be positioned with respect to the silicon substrate by the guide pin passing through the receptacle.

(4) In the positioning structure for the silicon substrate according to (3), the connector receiving portion may include a light focusing element at a position corresponding to the port.

(5) In the positioning structure for the silicon substrate according to (3) or (4), the silicon substrate, the connector receiving portion, and the ferrule may be positioned by the guide pin passing through a ferrule connected to an optical fiber.

(6) In the positioning structure for the silicon substrate according to (5), the connector receiving portion may include a spacer located on a side on which the connector receiving portion is connected to the ferrule.

(7) The positioning structure for the silicon substrate according to any one of (3) to (6) may include a refractive-index matching agent provided between the connector receiving portion and the silicon substrate.

(8) In the positioning structure for the silicon substrate according to any one of (1) to (7), the groove may have a V-shaped or inverted trapezoidal cross-sectional shape.

(9) In the positioning structure for the silicon substrate according to any one of (1) to (7), the substrate surface may be a (100) plane of a silicon crystal forming the silicon substrate, and a surface of the groove may include at least two (111) planes of the silicon crystal.

(10) In the positioning structure for the silicon substrate according to (9), the guide pin may be positioned with respect to the silicon substrate by a cylindrical side surface of the guide pin being in contact with each of the two (111) planes.

### BRIEF DESCRIPTION OF THE DRAWINGS

FIG. 1 is a perspective view illustrating an example of a positioning structure that positions, with respect to an optical fiber ferrule, a silicon substrate including a photonic integrated circuit;

FIG. 2 is an exploded side view illustrating the positioning structure illustrated in FIG. 1 together with the ferrule;

FIG. 3 is a three-view drawing illustrating the silicon substrate to which a guide pin illustrated in FIG. 1 is attached;

FIG. 4 is a cross-sectional view of the silicon substrate taken along line IV-IV of FIG. 3;

FIG. 5 is a cross-sectional view of another example of the silicon substrate taken along line V-V of FIG. 3;

FIG. 6 is a diagram illustrating an end surface on the ferrule side of a receptacle illustrated in FIG. 1;

FIG. 7 is a cross-sectional view taken along line VII-VII of FIG. 6;

FIG. 8 is a diagram illustrating an end surface on the receptacle side of the ferrule illustrated in FIG. 1;

FIG. 9 is a perspective view illustrating another example of the positioning structure for the silicon substrate;

FIG. 10 is a side view illustrating an example of a positioning structure that positions the silicon substrate with respect to the optical fiber ferrule and that does not include a receptacle;

FIG. 11 is a graph illustrating a signal strength of each channel connected by the positioning structure of the present disclosure in an example, compared with active alignment;

FIG. 12 is a graph illustrating the mounting accuracy of the positioning structure of the present disclosure based on FIG. 11; and

FIG. 13 is a graph illustrating the mounting accuracy of the positioning structure of the present disclosure based on FIG. 11.

### DESCRIPTION OF THE PREFERRED EMBODIMENTS

There is a problem in that performing active optical alignment individually requires time and effort. Accordingly, passive alignment in which optical continuity is not checked during implementation has been considered. However, in passive alignment, it is difficult to adjust positions with high accuracy, resulting in a problem of increased connection loss.

As will be described below, the present disclosure provides a positioning structure for a silicon substrate that improves the accuracy of alignment with the silicon substrate.

An embodiment of the present disclosure will be described below with reference to the drawings. The drawings that will be referred to in the following description are schematic diagrams. The dimensional ratios and so forth of the objects illustrated in the drawings may sometimes be different from those of the actual objects.

### Overall Structure

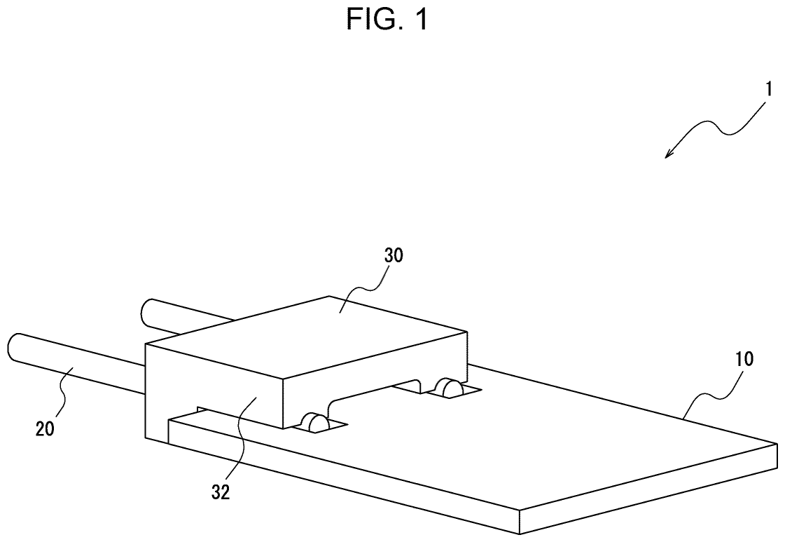

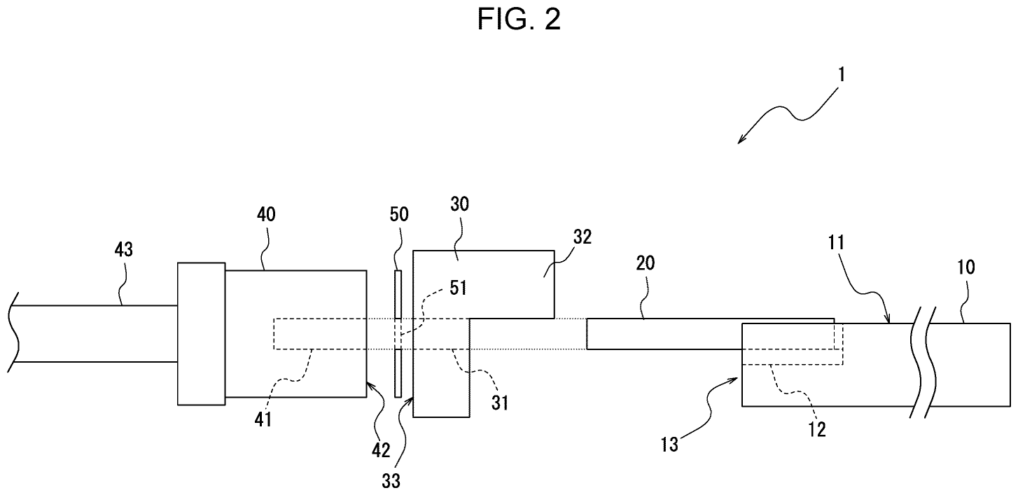

In an embodiment of the present disclosure, a positioning structure 1 is a structure that provides accurate positioning for connecting a silicon substrate 10 to a ferrule 40 (see FIG. 2) to which one or more optical fibers are connected. As illustrated in the perspective view in FIG. 1, the positioning structure 1 includes the silicon substrate 10, guide pins 20, and a receptacle 30 serving as a connector receiving portion. In the present disclosure, a connector on the one or more optical fibers side will be referred to as a “plug,” and a connector on the silicon substrate 10 side will be referred to as a “receptacle.” The ferrule 40 is a component constituting the plug. As will be described later, the receptacle 30 is not an essential component of the positioning structure 1 according to the present disclosure.

As illustrated in FIG. 2, one or more grooves 12 having a linear shape is formed in a substrate surface 11 of the silicon substrate 10. The one or more grooves 12 reaches a side surface 13 that is one side surface of the silicon substrate 10. In the one or more grooves 12 having a linear shape, the guide pins 20 are positioned along the one or more grooves 12 and fixed thereto by adhesion or the like. Each of the guide pins 20 extends beyond the side surface 13 to the outside of the silicon substrate 10.

Through-holes 31 are formed in the receptacle 30 such that the inner diameter of each of the through-holes 31 is approximately equal to the outer diameter of each of the guide pins 20. The positioning structure 1 is formed by inserting each of the guide pins 20 into a respective one of the through-holes 31 of the receptacle 30, bringing a surface of the receptacle 30 facing the silicon substrate 10 into contact with the side surface 13 of the silicon substrate 10, and fixing these surfaces to each other. A portion of the receptacle 30 on the silicon substrate 10 side serves as a projecting portion 32 projecting toward the silicon substrate 10. When the silicon substrate 10 and the receptacle 30 are connected to each other, the projecting portion 32 is positioned in such manner as to cover a portion of the substrate surface 11 and a portion of each of the guide pins 20. An upper portion of each of the guide pins 20 and the lower surface of the projecting portion 32 may be fixed to each other by an adhesive or the like. Each of the guide pins 20 is firmly fixed in place by being sandwiched between the one or more grooves 12 and the lower surface of the projecting portion 32.

The receptacle 30 can be connected to the ferrule 40 connected to a ribbon optical fiber cable 43. The ferrule 40 includes guide pin holes 41 open to a ferrule end surface 42 facing the receptacle 30. Each of the guide pin holes 41 has an inner diameter approximately equal to the outer diameter of each of the guide pins 20. Each of the guide pins 20 is slidable within a respective one of the guide pin holes 41. The guide pins 20 projecting from a receptacle end surface 33 of the receptacle 30 facing the ferrule 40 are inserted and fitted into their respective guide pin holes 41, so that the receptacle 30 and the ferrule 40 are connected to each other.

A spacer 50 is disposed on the receptacle end surface 33 as necessary. The spacer 50 includes holes 51 each of which is formed in a central portion of the spacer 50 to allow a respective one of the guide pins 20 and light to pass therethrough. The spacer 50 is used to finely adjust the distance between the receptacle 30 and the ferrule 40. The spacer 50 can adjust the distance between the ferrule end surface 42 and a light focusing element 35, thereby improving the optical coupling efficiency between the ferrule 40 and the silicon substrate 10.

In the positioning structure 1 according to the present disclosure, the common guide pins 20 fixed in the one or more grooves 12 of the silicon substrate 10 pass through the receptacle 30 and the ferrule 40, so that the silicon substrate 10, the receptacle 30, and the ferrule 40 can be positioned with high accuracy.

### Silicon Substrate

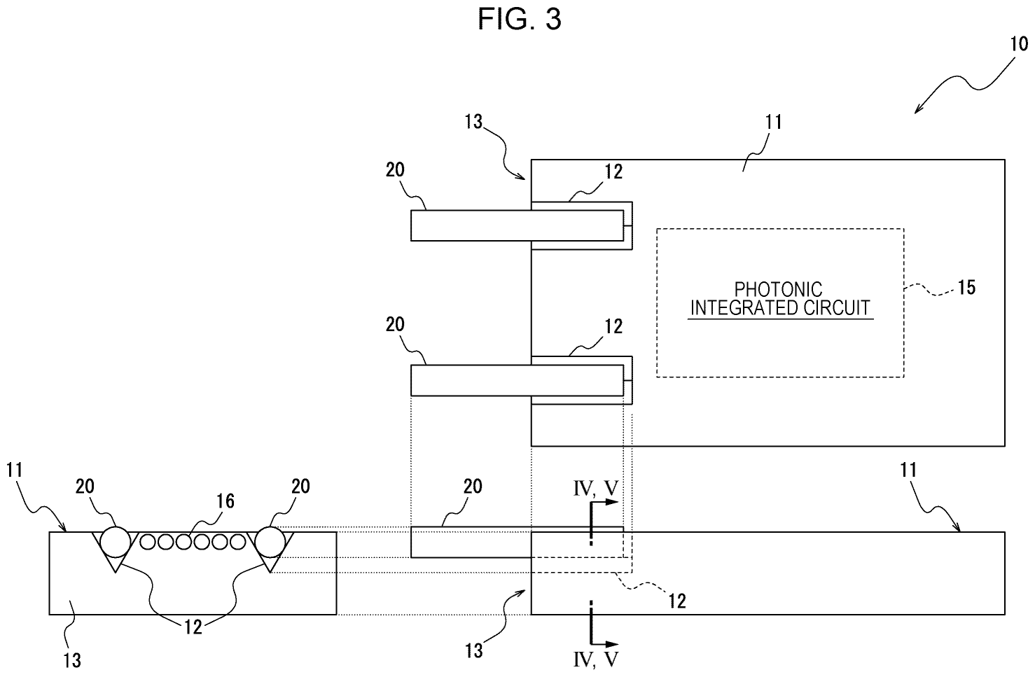

A configuration example of the silicon substrate 10 according to an embodiment will be described with reference to FIG. 3.

The silicon substrate 10 is a silicon photonics substrate on which a photonic integrated circuit 15, such as an optical transceiver, is formed, the photonic integrated circuit 15 including a fine waveguide formed therein. The photonic integrated circuit 15 includes a silicon photonics chip in which an optical element and an electronic element are integrated on the silicon substrate 10. The silicon substrate 10 may have a rectangular shape when viewed in plan view. However, the shape of the silicon substrate 10 is not limited to a rectangular shape. An optical waveguide connected to the photonic integrated circuit 15 is formed in the silicon substrate 10. One or more ports 16 through which light is input or output to the waveguide are formed in the side surface 13 of the silicon substrate 10. The one or more ports 16 may be provided in any number such as 4, 6, 8, 12, or 16. The one or more ports 16 may be arranged on the side surface 13 in a direction along the substrate surface 11. The one or more ports 16 may be arranged not only in a single row but also in multiple rows.

As described above, the one or more grooves 12 are formed in the substrate surface 11 of the silicon substrate 10. In order to reduce the possibility of rotation of the silicon substrate 10 and the receptacle 30 around the guide pin 20 during positioning, it is desirable that the one or more grooves 12 be provided in a number of two or more, and that the guide pins 20 arranged in the one or more grooves 12 be provided in a number of two or more. However, the number of the one or more grooves 12 may be reduced to one the single groove 12 may be provided by combining with other anti-rotation means or the like. In the case illustrated in FIG. 3, the two grooves 12 are arranged on the side surface 13 such that one of them is located on one side and the other is located on the opposite side of an array of the ports 16. Each of the grooves 12 extends linearly from a specific position on the substrate surface 11 to the side surface 13 of the silicon substrate 10. When the multiple grooves 12 are provided, the grooves 12 extend parallel to each other. A direction in which the grooves 12 extend can be a direction perpendicular to the side surface 13.

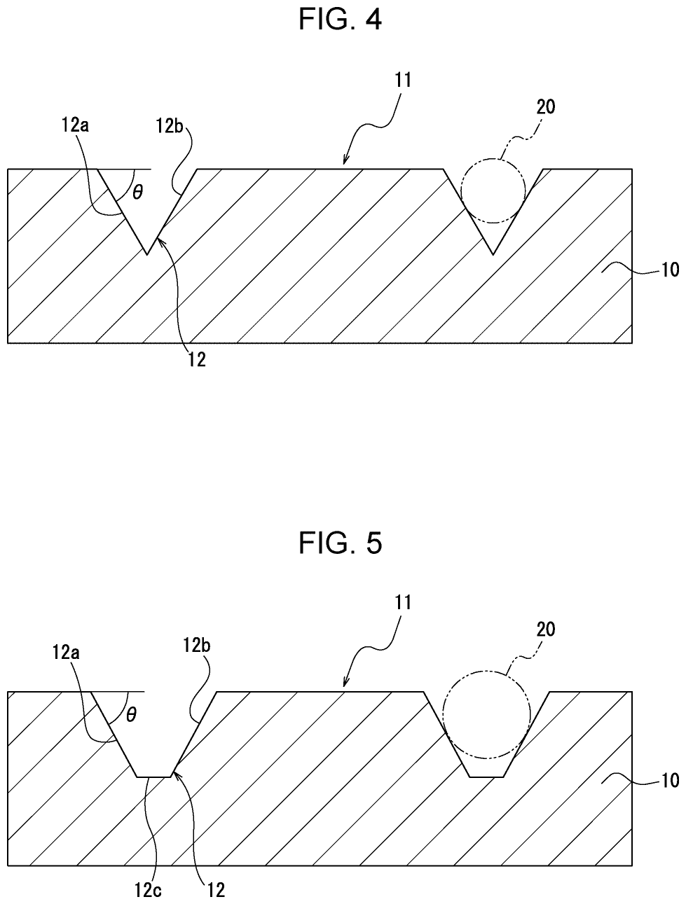

As illustrated in the cross-sectional view in FIG. 4, the one or more grooves 12 can be the two V-shaped grooves 12. Each of the V-shaped grooves 12 includes two groove inclined surfaces 12a and 12b serving as groove surfaces.

The substrate surface 11 is a (100) plane of a silicon crystal forming the silicon substrate 10. Each of the groove inclined surfaces 12a and 12b of the grooves 12 is a (111) plane of the silicon crystal. By performing anisotropic etching using an alkaline aqueous solution such as a KOH solution on the substrate surface 11, which is a (100) plane, the V-shaped grooves 12 can be formed with high precision. The groove inclined surfaces 12a and 12b of the V-shaped grooves 12 each form an angle θ of 54.7° with respect to the substrate surface 11 with high accuracy. The angle θ of each of the groove inclined surfaces 12a and 12b is an angle that is strictly determined by a crystal plane of single-crystal silicon. The grooves 12 are etched such that each of the groove inclined surfaces 12a and 12b forms the angle θ, which is determined by a crystal plane, and thus, the angle, width, position, and the like can be easily controlled.

### Guide Pin

Each of the guide pins 20 is a high-precision, high-rigidity pin having a cylindrical shape with a precisely defined shape and size. The guide pins 20 can be made of a metal such as a stainless steel; however, they are not limited to being made of such a metal. The guide pins 20 may also be made of a material such as a ceramic or a resin. Each of the guide pins 20 is disposed in a respective one of the V-shaped grooves 12 and, a cylindrical side surface of the guide pin 20 is brought into contact with the groove inclined surfaces 12a and 12b, so that each of the guide pins 20 is accurately positioned with respect to the silicon substrate 10. As each of the guide pins 20, a high-precision product with a diameter of 698.5+0.5 μm that is commercially available for use in a single-mode optical fiber connector can be used. Another commercially available product with a different size may also be used as each of the guide pins 20.

The pitch of the two V-shaped grooves 12, or the distance between the apexes of the V-shapes, can be set equal to the center-to-center distance between guide holes that is adopted as a standard in the ferrule 40. For example, the pitch of the V-shaped grooves 12 can be 4.6 mm. In this way, the commercially available ferrule 40 can be easily connected to the receptacle 30.

The shape of each of the grooves 12 is not limited to the V-shape. For example, as illustrated in FIG. 5, the cross-sectional shape of each of the grooves 12 may be an inverted trapezoidal shape narrowing from the substrate surface 11 toward the interior of the silicon substrate 10. Also in this case, the two groove inclined surfaces 12a and 12b, each of which is a (111) plane of the silicon crystal, are formed by anisotropic etching, with a groove bottom surface 12c interposed between the two groove inclined surfaces 12a and 12b. Each of the guide pins 20 is disposed in the corresponding groove 12 having an inverted trapezoidal shape, and the cylindrical side surface of the guide pin 20 is brought into contact with the groove inclined surfaces 12a and 12b, so that each of the guide pins 20 is accurately positioned with respect to the silicon substrate 10.

### Receptacle

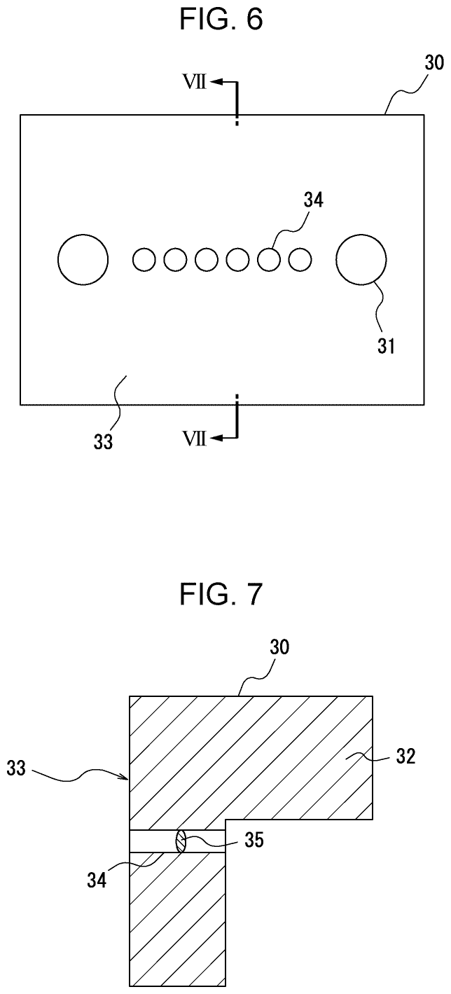

The receptacle 30 will be described with reference to FIG. 6 and FIG. 7. The receptacle 30 may be made of any material including a resin. In addition to the through-holes 31 for the guide pins 20, optical path holes 34 are formed at positions in the receptacle 30 corresponding to the ports 16 of the silicon substrate 10. The interior of each of the optical path holes 34 may be filled with air or may be filled with an optical material transparent to light propagating through the optical material.

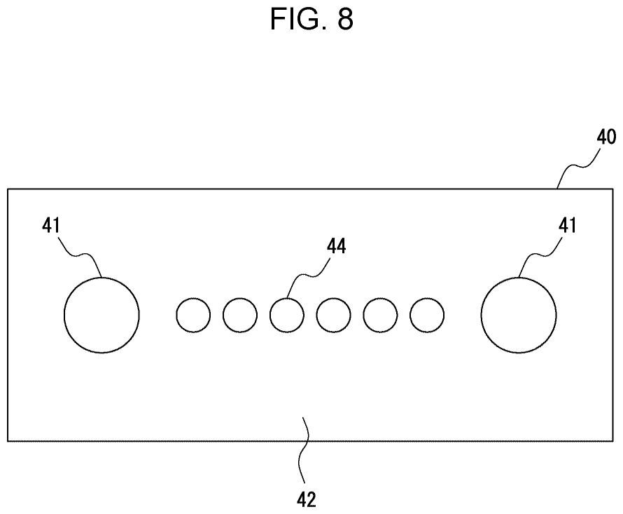

In each of the optical path holes 34, the light focusing element 35 may be disposed to correspond to a respective one of the ports 16. Each of the light focusing elements 35 includes, for example, a lens. Each of the light focusing elements 35 couples light emitted from one of optical fiber holes 44 (see FIG. 8) on the ferrule end surface 42 to the corresponding port 16 of the silicon substrate 10. Each of the light focusing elements 35 also couples light emitted from the corresponding port 16 of the silicon substrate 10 toward the corresponding optical fiber hole 44 on the ferrule end surface 42. Therefore, the light focusing elements 35 can reduce connection loss in the receptacle 30 and increase the coupling efficiency of light. In FIG. 7, although the light focusing element 35 is provided at one location in the length direction of the optical path hole 34, each of the light focusing elements 35 may have a size covering the entire length of the corresponding optical path hole 34. The interior of each of the optical path holes 34 is not necessarily provided with the light focusing element 35. In this case, the length of each of the optical path holes 34 is appropriately adjusted such that light is coupled. Microlenses may be provided at the ports 16 of the silicon substrate 10 and at end surfaces of the one or more optical fibers disposed at the ferrule end surface 42.

The positioning structure 1 may include a refractive-index matching agent between the silicon substrate 10 and the receptacle 30. The refractive-index matching agent may be a liquid or a solid. The refractive-index matching agent may be an ultraviolet curable resin functioning as an adhesive between the silicon substrate 10 and the receptacle 30. By providing the refractive-index matching agent, losses caused by reflection or the like at the interfaces between the ports 16 of the silicon substrate 10 and the optical path holes 34 of the receptacle 30 can be reduced.

### Ferrule

The ferrule 40 is a component of a connector typically used for mechanically connecting multiple optical fibers to each other. An MT (mechanically transferable) ferrule for multi-core optical connectors can be used as the ferrule 40. The ferrule 40 functions as a terminal configured to hold multiple optical fibers. The ferrule 40 aligns end portions of optical fibers included in the ribbon optical fiber cable 43 with the optical fiber holes 44 of the ferrule end surface 42. The ferrule 40 may be made of a resin such as PPS (polyphenylene sulfide). The material of the ferrule 40 is not limited to a resin, and the ferrule 40 may be made of a glass material or another material such as a ceramic material.

As illustrated in FIG. 8, the ferrule 40 includes the plurality of optical fiber holes 44 at the ferrule end surface 42, and each of the end portions of the optical fibers is positioned in a respective one of the optical fiber holes 44. Guide pin holes 41 are provided on both sides of the plurality of optical fiber holes 44, and the guide pins 20 for connection are inserted into the guide pin holes 41. Each of the end portions of the optical fibers may be polished and may be arranged in such a manner as to slightly protrude from the ferrule end surface 42. When the receptacle 30 and the ferrule 40 are connected to each other by using the guide pins 20, the optical path holes 34 of the receptacle 30 are positioned in such a manner as to face their respective optical fiber holes 44. The ferrule 40 has high dimensional accuracy at a submicron level.

By inserting the guide pins 20 into the guide pin holes 41, the ferrule 40 can be positioned by being fitted to the guide pins 20. The ferrule 40 is detachably engaged with the guide pins 20 and the receptacle 30. A fastener or the like for securing a connected state may be provided between the plug, which includes the ferrule 40, and the receptacle 30.

With the above-described configuration, by using the positioning structure 1 according to the present disclosure, the silicon substrate 10, the receptacle 30, and the plug including the ferrule 40 are positioned with high accuracy and connected to each other, using the guide pins 20 as references. In particular, since the V-shaped grooves 12, each of which has an angle precisely defined by the crystal orientation of single-crystal silicon, and the guide pins 20 whose sizes are precisely defined are used for the positioning between the silicon substrate 10 and the guide pins 20, accurate positioning can be achieved.

By setting the pitch of the two grooves 12 to be equal to the distance between guide holes adopted as a standard in the ferrule 40, each of the fibers of the ribbon optical fiber cable 43 can be easily connected to a respective one of the ports 16 of the photonic integrated circuit 15 of the silicon substrate 10 by using the commercially available ferrule 40.

According to the present disclosure, when the positioning structure 1 is applied to the silicon substrate 10, which includes the photonic integrated circuit 15, and used for connection with each of the optical fibers of the ferrule 40, high-accuracy alignment can be achieved, thereby enabling high-accuracy connection in passive alignment. According to the present disclosure, the positioning structure 1 can detachably connect the silicon substrate 10 equipped with the photonic integrated circuit 15 and the ferrule 40 connected to the ribbon optical fiber cable 43 to each other.

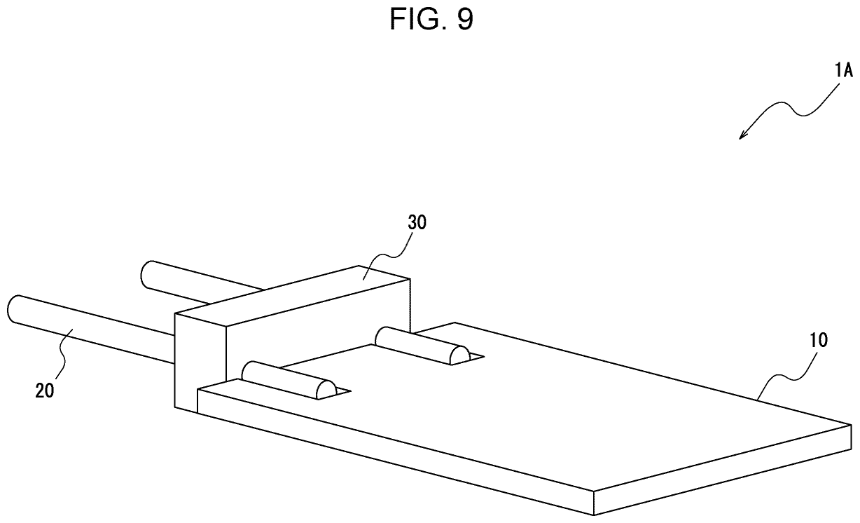

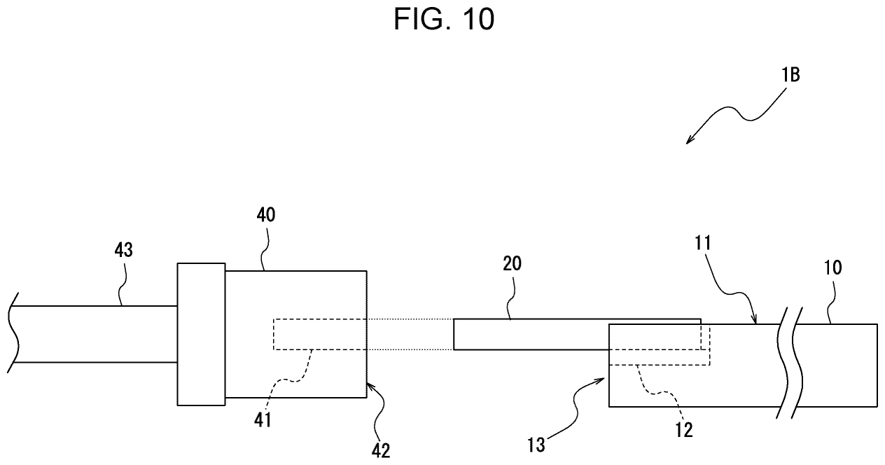

In another embodiment, a positioning structure 1A may be configured as illustrated in the perspective view in FIG. 9. In this case, the shape of the receptacle 30 differs from that illustrated in FIG. 1, and the receptacle 30 does not include the projecting portion 32. Accordingly, the receptacle 30 illustrated in FIG. 9 does not cover either an upper portion of the silicon substrate 10 or an upper portion of each of the guide pins 20. However, in the positioning structure 1A illustrated in FIG. 9, each of the guide pins 20 is accurately positioned with respect to the silicon substrate 10 and fixed in place by an adhesive or the like. Then, the positioning structure 1A can accurately position the silicon substrate 10, the receptacle 30, and the ferrule 40 in the same and/or similar manner as the positioning structure 1 illustrated in FIG. 1.

In still another embodiment illustrated in FIG. 10, a positioning structure 1B may have a configuration that does not include the receptacle 30. The positioning structure 1B illustrated in FIG. 10 can be directly connected to the ferrule 40. In this case, the guide pins 20 are inserted into their respective guide pin holes 41 of the ferrule 40, and each of the ports 16 on the side surface 13 of the silicon substrate 10 can be directly connected to a respective one of the end portions of the optical fibers, which are arranged in their respective optical fiber holes 44 of the ferrule end surface 42. Even in such a configuration, the guide pins 20 are positioned with high accuracy with respect to the silicon substrate 10, and thus, the silicon substrate 10 and the ferrule 40 can be positioned and connected to each other with high accuracy.

### Evaluation of Positioning Structure

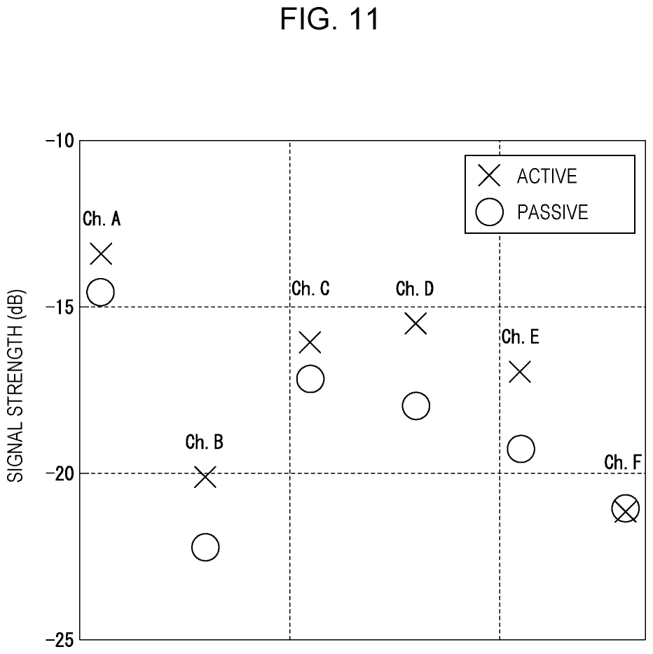

FIG. 11 is a graph illustrating the signal strength of light transmitted when the silicon substrate 10, the receptacle 30, and the ferrule 40 are connected using the positioning structure 1 illustrated in FIG. 1, in comparison with the signal strength when they are connected by active alignment with minimum loss. In this test, six channels Ch. A to Ch. F connecting the six ports 16 on the silicon substrate 10 side to six optical fiber ends on the ferrule end surface 42 of the ferrule 40 side were used. In FIG. 11, the signal strengths when connected by active optical alignment are indicated by “x” (cross). The signal strengths of the channels connected by passive optical alignment according to a method of the present disclosure are indicated by “o” (circle). According to the graph, the difference in signal strength between active alignment and passive alignment was 1.48 dB on average, with a maximum difference of 2.46 dB.

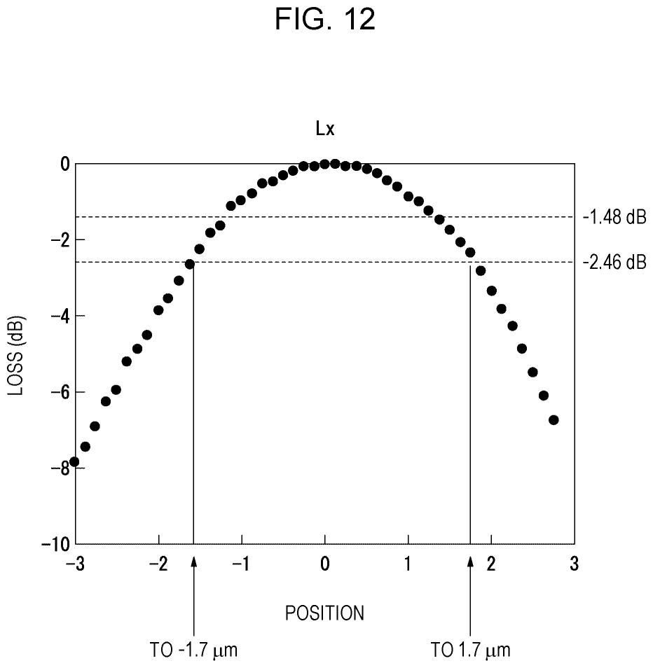

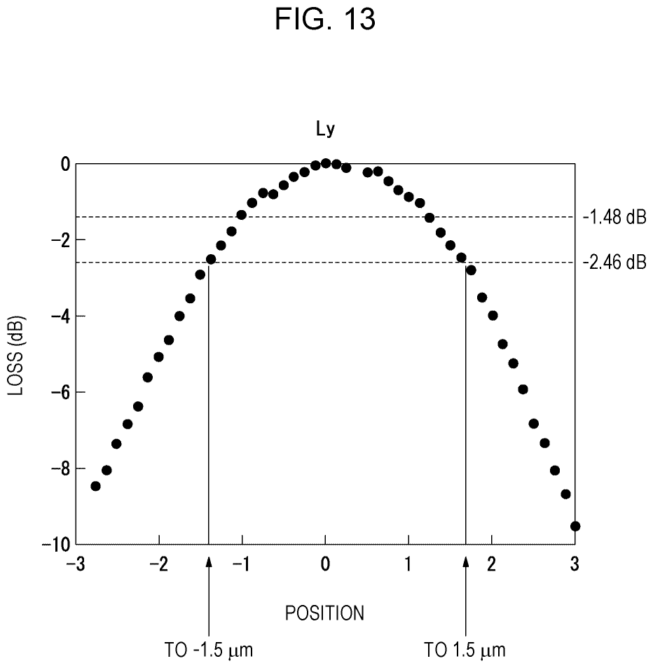

FIG. 12 and FIG. 13 are graphs each illustrating the relationship between positional deviation and loss in the active alignment. In FIG. 12, the horizontal axis denotes positional deviation in the left-right direction (hereinafter referred to as “lateral”) when the side surface 13 is viewed from the front. As can be seen from FIG. 12, a loss of 2.46 dB corresponds to a lateral positional deviation of about 1.7 μm. In FIG. 13, the horizontal axis denotes positional deviation in a direction perpendicular to the substrate surface 11 (hereinafter referred to as “vertical”). As can be seen from FIG. 13, a loss of 2.46 dB corresponds to a vertical positional deviation of about 1.5 μm. From the above, the maximum positional deviation from an optimal position when using the positioning structure 1 according to the present disclosure was at most 1.7 μm.

As described above, by using the positioning structure 1 according to the present disclosure for connecting a silicon photonics substrate and an optical fiber, even with implementation using passive optical alignment, high-accuracy implementation with an error of 1.7 μm or less can be achieved compared to active alignment. Therefore, by using the positioning structure 1 according to the present disclosure, a low-loss connection between the silicon substrate 10, the receptacle 30, and the ferrule 40 can be achieved without performing active optical alignment.

Although the embodiments described above are representative examples, it is apparent to those skilled in the art that many modifications and replacements can be made within the gist and the scope of the present invention. Therefore, the present invention should not be construed as limited to the embodiments and examples described above, and various modifications and/or changes can be made without departing from the scope of the claims.

What is claimed is:

1. A positioning structure for a silicon substrate, comprising:
a silicon substrate comprising a substrate surface in which at least one groove having a linear shape is formed; and
a guide pin positioned along the at least one groove,
wherein the at least one groove reaches a side surface of the silicon substrate, and the guide pin extends beyond the side surface to outside of the silicon substrate.

2. The positioning structure for the silicon substrate according to claim 1, further comprising:
a connector receiving portion positioned with respect to the silicon substrate by the guide pin passing through the connector receiving portion.

3. The positioning structure for the silicon substrate according to claim 2,
wherein an optical waveguide is formed in the silicon substrate, and a port through which light is input or output to the optical waveguide is formed on the side surface, and
wherein the connector receiving portion is a receptacle configured to be positioned with respect to the silicon substrate by the guide pin passing through the receptacle.

4. The positioning structure for the silicon substrate according to claim 3,
wherein the connector receiving portion comprises a light focusing element at a position corresponding to the port.

5. The positioning structure for the silicon substrate according to claim 3,
wherein the silicon substrate, the connector receiving portion, and the ferrule are positioned by the guide pin passing through a ferrule connected to an optical fiber.

6. The positioning structure for the silicon substrate according to claim 5,
wherein the connector receiving portion comprises a spacer located on a side on which the connector receiving portion is connected to the ferrule.

7. The positioning structure for the silicon substrate according to claim 3, comprising:
a refractive-index matching agent provided between the connector receiving portion and the silicon substrate.

8. The positioning structure for the silicon substrate according to claim 1,
wherein the groove has a V-shaped or inverted trapezoidal cross-sectional shape.

9. The positioning structure for the silicon substrate according to claim 1,
wherein the substrate surface is a (100) plane of a silicon crystal forming the silicon substrate, and a surface of the groove includes at least two (111) planes of the silicon crystal.

10. The positioning structure for the silicon substrate according to claim 9,
wherein the guide pin is positioned with respect to the silicon substrate by a cylindrical side surface of the guide pin being in contact with each of the two (111) planes.
